(19) United States
(12) Patent Application Publication
(10) Pub. No.: US 2004/0075908 A1
(43) Pub. Date: Apr. 22, 2004

(54) Multilayer mirror

(76) Inventors: Fei Chuang Chen, Chatsworth, CA (US); Chongfei Shen, Alhambra, CA (US); Xiucheng Wu, Temple City, CA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/272,821

(22) Filed: Oct. 16, 2002

(51) Int. Cl. G02B 1/10

(52) U.S. Cl. 359/584; 359/585; 359/885

(57) ABSTRACT

A multilayer mirror for incident electromagnetic waves includes a plurality of layers having different thicknesses. The plurality of layers includes at least two materials. At least one of the materials has a non-zero absorptance at a given wavelength. In some examples, the thicknesses of the respective layers of the multilayer mirror provide the multilayer mirror with a reflectivity at the given wavelength that is greater than a reflectivity of a second multilayer mirror formed of quarter wavelength thick layers of the same materials and having the same number of layers as the multilayer mirror. In other examples, the thicknesses are selected to strike a balance between high reflectivity and another property, such as transmittance or absorptance.

### FIELD OF THE INVENTION

The present invention relates to multilayer mirrors.

### BACKGROUND OF THE INVENTION

Vertical cavity surface emitting lasers (VCSEL) are a significant advance in optical communications. VCSELs offer many advantages over traditional edge emitting lasers, including but not limited to single mode operation, circular beam shape for easier coupling to fibers, and lower fabrication cost. VCSELs also enable new applications such as parallel fiber optic data communication. VCSEL requires high reflectivity mirrors that operate at long wavelengths (e.g., 1310 nanometers).

The Distributed Bragg Reflector (DBR) has been used in applications that called for highly reflective mirrors. The conventional design of a DBR uses stacks of quarter wavelength thick layers of alternating dielectric materials. In the DBR configuration, the optical power is nearly evenly distributed in the two materials. The reflections at each interface interfere and are exactly in phase when the thickness of each layer is one quarter wavelength thick. The constructive interference of reflection at each interface is the reason for high reflectivity of the complete DBR structure. The overall reflectivity approaches a maximum asymptotic value as more and more layers are added. For a pair of materials having zero absorptance, the maximum asymptotic value is 100%. If either or both of the materials have a non-zero absorptance, the asymptotic value is less than 100%.

A pair of materials having a high refractive index contrast is chosen to make the DBR. The reflectivity at the interface of two materials increases with increasing contrast between the respective refractive indices of the two materials. To achieve a given desired reflectivity, fewer layers are needed using a pair of materials having a high refractive index contrast.

Amorphous silicon (a—Si) and Alumina (Al₂O₃) have high refractive index contrast. Another example of a pair of materials with high refractive index contrast is a—Si and magnesium oxide (MgO). Due to strong absorption of a—Si at the wavelength of 1310 nanometers (nm), the maximum asymptotic reflectivity for a DBR having an infinite number of layers (including a—Si) is 99.37%.

Improved dielectric mirrors are desired for use in applications such as long wavelength (e.g., 1310 nm) VCSELs.

### SUMMARY OF THE INVENTION

In some embodiments, a multilayer mirror for incident electromagnetic waves includes a plurality of layers having at least two different thicknesses. The plurality of layers includes at least two materials. At least one of the materials has a non-zero absorptance at a given wavelength. The thicknesses of the respective layers of the multilayer mirror provide the multilayer mirror with a reflectivity at the given wavelength that is greater than a reflectivity of a second multilayer mirror formed of quarter wavelength thick layers of the same materials and the same number of layers as the multilayer mirror.

In other embodiments, a multilayer mirror for incident electromagnetic waves includes a plurality of layers having at least two different thicknesses. The plurality of layers includes at least two materials. A least one of the materials has a non-zero absorptance at a given wavelength. Each of the materials has a non-zero transmittance at the given wavelength. The thicknesses of the respective layers of the multilayer mirror provide the multilayer mirror with a reflectivity at the given wavelength that is greater than, approximately equal to or slightly less than a reflectivity of a second multilayer mirror formed of quarter wavelength thick layers of the same materials and the same number of layers as the multilayer mirror. The thicknesses provide the multilayer mirror with a transmittance substantially greater than a transmittance of the second multilayer mirror.

In other embodiments, a multilayer mirror for incident electromagnetic waves includes a plurality of layers having at least two different thicknesses. The plurality of layers includes at least two materials. At least a first one of the materials has a substantially higher thermal conductivity than a second one of the materials. The thickness of the respective layers of the multilayer mirror provide the multilayer mirror with a reflectivity at a given wavelength that is greater than, equal to or slightly less than a reflectivity of a second multilayer mirror formed of quarter wavelength thick layers of the same materials and the same number of layers as the multilayer mirror. The thickness of the respective layers of the multilayer mirror provides the multilayer mirror with a thermal conductivity that is substantially greater than the thermal conductivity of the second multilayer mirror.

### BRIEF DESCRIPTION OF THE DRAWINGS

FIG. 1 is a diagram showing the normalized electric field intensity (squared) in each layer of an exemplary multilayer mirror.

FIG. 2 is a diagram showing the reflectivity of an exemplary family of multilayer mirror designs, as a function of the number of layers.

FIG. 3 is a diagram showing the optical loss of a family of multilayer mirror designs, as a function of the number of layers.

### DETAILED DESCRIPTION

Although materials such as a—Si have long been known to have a non-zero absorptance at wavelengths of interest, conventional designs have assumed that reflectivity for mirrors having absorptive materials would also be maximized using the same quarter-wavelength thickness configuration that maximizes reflectivity for non-absorptive materials. The inventors have recognized that the traditional quarter-wavelength DBR thickness configuration optimized for zero-absorptance materials does not provide the best performance for materials having non-zero absorptance.

The exemplary embodiments described below provide configurations and techniques for improved performance in dielectric mirrors having at least one material with non-zero absorptance. The exemplary embodiments provide the ability to balance reflectivity, transmittance, and/or thermal conductivity in a dielectric mirror. Some embodiments have reflectivity greater than the maximum asymptotic reflectivity of the quarter-wavelength DBR configuration. Some embodiments have optical loss lower than the loss of a quarter-wavelength DBR configuration having the same materials and number of layers. Some embodiments have reflectivity greater than, approximately equal to or slightly lower than the maximum asymptotic reflectivity of the quarter-wavelength DBR configuration while providing a substantial increase in transmittance or thermal conductivity of the dielectric mirror stack.

A method is also described for designing and/or fabricating a high reflectivity mirror in which the optical thicknesses of the respective layers are selected based on selected physical properties of the materials used in the mirror. One or more physical properties to be enhanced are identified (e.g., absorption at the design wavelength, transmittance, or thermal conductivity). Once the property to be enhanced is selected, the layer thicknesses are determined using, for example, a computer program or an iterative manual calculation. An example of a suitable computer program is “TFCalc,” thin film design software developed and marketed by Software Spectra, Inc. of Portland, Oreg.

Although the examples described below include multilayer mirrors formed of dielectric materials, other embodiments of multilayer mirrors are formed by applying the concepts described below to mirrors comprising layers of semiconductor epitaxially grown on InP, GaAs, silicon or the like.

### EXAMPLE 1

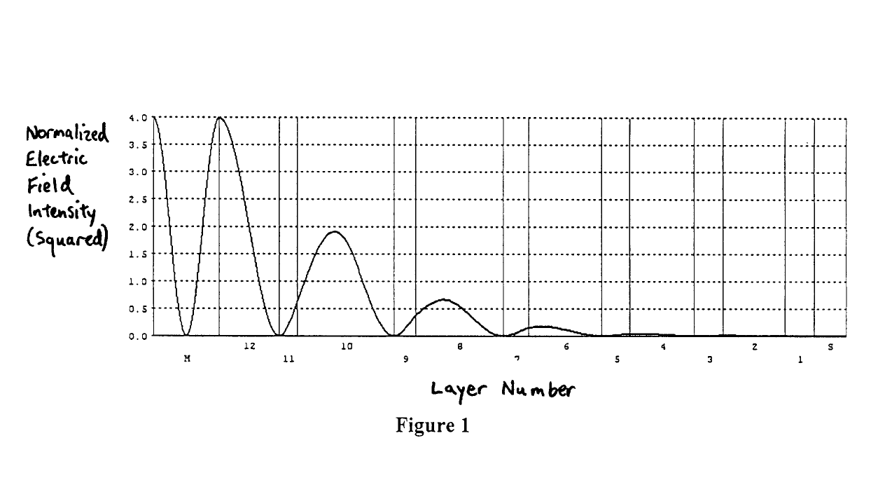

In some embodiments, a multilayer mirror for incident electromagnetic waves includes a plurality of layers having different thicknesses. The thicknesses can be selected to provide the highest possible reflectivity for any given pair of materials and given number of layers, when the absorptance of each material is taken into account. FIG. 1 is a diagram of an exemplary mirror having twelve layers numbered 1 through 12, from right to left, on InP (designated “m”). The incident light enters and exits through the air on the right side (designated, “s”). The plurality of layers includes at least two materials. This mirror is designed to include a—Si having a refractive index of 3.6 and Al₂O₃ having a refractive index of 1.74. (The refractive indices can be found in the literature or measured.) The mirror is designed to operate at a wavelength of 1310 nm. Table 1 specifies the configuration of the layers shown in FIG. 1 and the respective thicknesses.

TABLE 1

| Layer | Material | Thickness (nm) |
|---|---|---|
| Exit Medium (s) | air | |
| 1 | a-Si | 90.94 |
| 2 | Al₂O₃ | 191.36 |
| 3 | a-Si | 90.22 |
| 4 | Al₂O₃ | 201.01 |
| 5 | a-Si | 87.98 |
| 6 | Al₂O₃ | 230.04 |
| 7 | a-Si | 80.89 |
| 8 | Al₂O₃ | 273.52 |
| 9 | a-Si | 68.09 |
| 10 | Al₂O₃ | 302.76 |
| 11 | a-Si | 56.20 |
| 12 | Al₂O₃ | 188.23 |
| Incident Medium (m) | InP | |

The thickness of each layer is very approximately shown to scale in FIG. 1. In this example, the largest thickness (90.94 nm) of any of the a—Si layers is substantially less than the smallest thickness (188.23 nm) of any of the Al₂O₃ layers

In this example, at least one of the materials has a non-zero absorptance at a given wavelength (e.g., 1310 nm). The at least two materials include a first material having a non-zero absorptance at the given wavelength and a second material having substantially lower absorptance at the given wavelength than the first material. In this example, an absorption coefficient of 1000 cm⁻¹ is used for a—Si . Al₂O₃ has an absorption that is substantially zero at this wavelength.

A variety of techniques may be used to determine a highly reflective configuration of thicknesses for these materials and material properties. For example, the user can iteratively select different combinations of layer thicknesses and manually select a thickness at each succeeding pair of layers that provides the greater reflectivity. Further iteration is performed until desired properties are achieved. A variety of known numerical methods may be used for selecting the point at which the calculations converge to a desired solution. If any other property (e.g., transmittance or thermal conductivity) is to be enhanced or maximized, that property is also calculated at each iteration, and taken into account in the selection and convergence criteria.

Alternatively, a conventional software package for designing optical coatings may be used. Using such a tool, the user can provide an initial guess of the structure, for example 12 quarter wavelength thicknesses (six pairs) in alternating layers of a—Si and Al₂O₃ Some tools allow the user to select a target property at a given wavelength, and provide an option to request an optimized design of each thickness to closely approach the target property. The property may be, for example, a target reflectivity, transmittance, or thermal conductivity.

In the example of FIG. 1, a target reflectivity of 100% was input to find a layer thickness configuration to maximize reflectivity. The thicknesses of the respective layers of the multilayer mirror of FIG. 1 provide the multilayer mirror with a reflectivity of 99.6% at the given wavelength 1310 nm (in a configuration of only 12 layers of a—Si and alumina). This reflectivity is greater than a reflectivity of a second mirror having quarter wavelength thick layers of the same materials and in the same number as the mirror of Table 1. Also, this reflectivity is greater than a maximum asymptotic reflectivity 99.37% of a multilayer mirror (not shown) formed of an infinite number of quarter wavelength thick layers of the same materials.

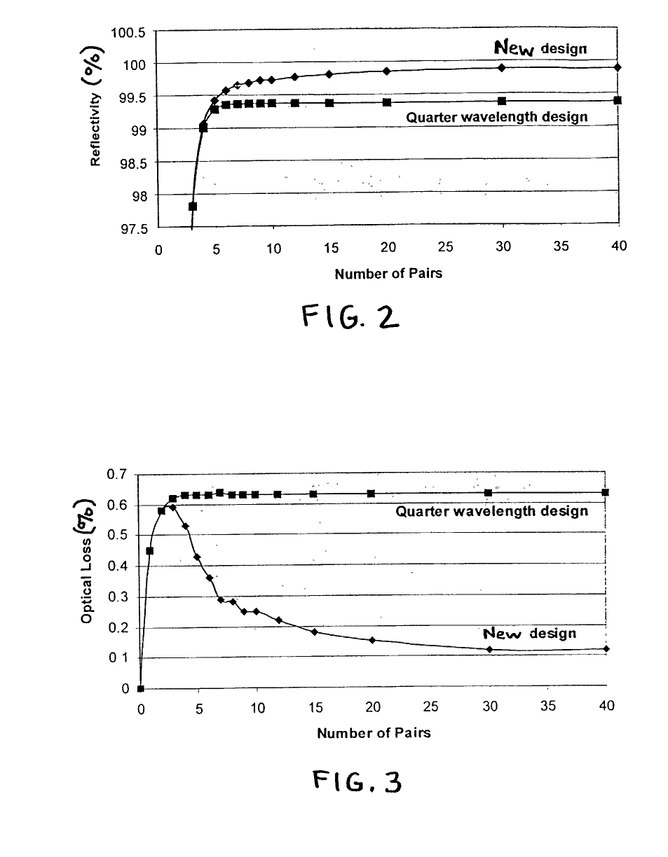

The specific design shown in FIG. 1 is one member of a family of designs, wherein each number of layers provides another reflectivity data point. For each number of layers, the same analysis is performed to select the thickness of each layer to enhance or maximize the reflectivity. The analysis can be performed manually or using a computer program. By combining the results from several different numbers of layers, the curves shown in FIGS. 2 and 3 are provided. Although the layer thicknesses are not listed herein for each data point in FIGS. 2 and 3, one or ordinary skill can readily determine the thicknesses using the methodology described herein for any combination of materials and number of layers.

FIG. 2 shows a comparison between the reflectivity of a quarter-wavelength thickness DBR configuration of a—Si and Al₂O₃ at 1310 nm and the reflectivity of a family of designs in which the thickness of each a—Si and Al₂O₃ layer is selected for highest reflectivity at 1310 nm, taking into account the absorptance of each material. The quarter-wavelength configuration very rapidly approaches an asymptotic limit of about 99.37% reflectivity, with very little improvement after about eight pairs of layers. The design that maximizes reflectivity while taking into account the absorptance clearly substantially outperforms the quarter-wavelength design for every configuration having five or more pairs. The family of designs of FIG. 2 continues to show substantial improvement in reflectivity well beyond the first eight pairs, up to about 20 pairs (approximately 99.8%), at which point the improvement from further additional layers tapers off. The designs of FIG. 2 that enhance reflectivity while taking into account the absorptance approach an asymptotic reflectivity of 99.88% with fewer than 40 layers (20 pairs) and substantially approach the asymptote with fewer than 80 layers (40 pairs).

In FIG. 1, the different optical thicknesses of the layers shows a difference between this design and the traditional quarter-wavelength design in which Bragg diffraction conditions are met. FIG. 1 shows the squared electric field intensity distribution in the structure.

The respective thicknesses of the plurality of layers are configured so that during use, an amount of optical power distributed in the first material (e.g., a—Si) is substantially less than an amount of optical power distributed in the second material (e.g., alumina). As shown in FIG. 1, the normalized (squared) electric field intensity is distributed in such a way that the optical power is mainly distributed in the non-absorbing material (e.g., alumina). The absorption is significantly reduced due to the low optical power in the absorbing material (e.g., a—Si).

FIG. 3 is a diagram showing the optical loss achievable with different numbers of a—Si and alumina layers, using a conventional quarter wavelength design and using a design that provides the highest reflectivity (for a given number of layers) while taking into account the absorptance of each material. The abscissa of FIG. 3 indicates the number of pairs of layers. The total absorption in the multilayer mirror structure is significantly reduced from that of a configuration of layers having the quarter-wavelength thickness. In the data points corresponding to 12 layer configurations (six pairs), the quarter-wavelength configuration has an optical loss of about 0.63%, while the configuration of FIG. 1 has an optical loss of only about 0.36%. Notably, the loss in the quarter-wavelength design rapidly increases to an asymptotic value of about 0.63%, while the loss of the family of designs of FIG. 3 (which takes the absorptance of each material into account) peaks at about 0.6% with three pairs of layers, drops below 0.3% with seven pairs of layers, drops below 0.2% with 15 pairs of layers, and asymptotically approaches about 0.12%.

Although FIG. 1 and Table 1 describe an example of a combination of a—Si and Al₂O₃ with InP as the incident medium and air as the exit medium, a similar procedure is followed to design a multilayer mirror using other materials.

Although FIG. 3 shows substantial reduction in optical loss when the reflectivity is maximized, a similar procedure can be applied to converge to the configuration of layer thicknesses that minimizes the optical loss.

Although FIGS. 2 and 3 show a family of configurations in which the reflectivity is maximized, a similar procedure can be applied to identify other configurations that have greater reflectivity than the quarter-wavelength mirrors with the same materials and same number of layers, but have lower reflectivity than specified in FIG. 2. For example, if a computer program is used to calculate the thicknesses, a reflectivity target can be input that is greater than the quarter-wavelength reflectivity for the same materials and number of layers, but less than the values shown in FIG. 2.

Although Table 1 specifies a configuration for a mirror that is to be used to highly reflect light at a wavelength of 1310 nm, the same design concepts can be used to design and fabricate a mirror that is suited to reflect light at any other desired wavelength.

Although the configuration of FIG. 1 and Table 1 maximizes reflectivity, other combinations of thicknesses may be selected by those of ordinary skill to enhance the reflectivity, while providing other desirable properties to the mirror.

### EXAMPLE 2

In example 2, a mirror configuration is designed to provide a desired transmittance. A multilayer mirror for incident electromagnetic waves includes a plurality of layers having different thicknesses. The plurality of layers includes at least two materials (e.g., a—Si and Al₂O₃ with InP as the incident medium and air as the exit medium). A least one of the materials (e.g., a—Si) has a non-zero absorptance at a given wavelength. Each of the materials has a non-zero transmittance at the given wavelength (e.g., 1310 nm).

In this example, two goals were selected: (1) to achieve at least 0.3% transmission and (2) to achieve greater than 99.3% reflection. A coating analysis computer program was used to determine the design for the selected parameters. An initial configuration of 10 alternating quarter wavelength layers (five pairs) was selected, with target parameters of 99.5% reflection and 0.7% transmission. Table 2 specifies the configuration of the layers and the respective thicknesses.

TABLE 2

| Layer | Material | Thickness (nm) |
|---|---|---|
| Exit Medium (s) | air | |
| 1 | a-Si | 90.50 |
| 2 | Al₂O₃ | 213.23 |
| 3 | a-Si | 85.15 |
| 4 | Al₂O₃ | 253.20 |
| 5 | a-Si | 74.58 |
| 6 | Al₂O₃ | 291.00 |
| 7 | a-Si | 61.46 |
| 8 | Al₂O₃ | 312.12 |
| 9 | a-Si | 51.47 |
| 10 | Al₂O₃ | 188.22 |
| Incident Medium (m) | Inp | |

The thicknesses of the respective layers of the dielectric mirror in Table 2 provide the dieletric mirror with a reflectivity of 99.32% at the given wavelength 1310 nm, which is approximately equal to the maximum asymptotic reflectivity (99.37%) of a second dielectric mirror (not shown) formed of quarter-wavelength thick layers of the same materials. (When selecting configurations that improve transmittance, alternative designs may be elected having reflectivities which are greater than, equal to, or slightly less than the reflectivity of a mirror having quarter wavelength thick layers of the same materials and the same number of layers.) The thicknesses in Table 2 provide the dielectric mirror with a transmittance of 0.35%. This transmittance is substantially greater than a transmittance (0.09%) of a third dielectric mirror (not shown) formed of quarter-wavelength thick layers of the same materials and the same number (10) of layers as the dielectric mirror specified in Table 2.

One of ordinary skill can readily design other mirrors with improved reflectivity and transmittance relative to the quarter-wavelength layer configuration. For example, as shown by FIG. 2, a significant improvement in reflectivity is achieved when the number of layers is increased beyond five pairs of layers. With only a few more layers (e.g., seven to eight pairs), a reflectivity is achieved that is greater than the maximum asymptotic reflectivity (99.37%) of the quarter wavelength mirror using the same materials, while the transmittance is still substantially greater than the 0.09% transmittance of a quarter wavelength mirror having the same materials and the same number of layers. It is understood that increasing the number of layers further improves reflectivity, but reduces the overall transmittance of the mirror. Further, for any given number of layers of a given pair of materials, the reflectivity can be designed to exceed to reflectivity of a second mirror having the same number of quarter-wavelength thick layers.

Although Tables 1 and 2 describe configurations having only two materials, other designs may include more than two materials.

### EXAMPLE 3

Although the configurations described above use an incident medium of InP and an exit medium of air, other incident and exit media may be used. In the following example, a goal of achieving high reflectivity with a small number of layers is achieved using a—Si, Al₂O₃ and Au, with an incident medium of InP.

Table 3 specifies a configuration having seven alternating layers of a—Si and Al₂O₃, with InP as the incident medium and gold as the exit medium). The configuration was designed to provide the highest reflectivity (by setting the target reflectivity to 100% in a thin film design program).

TABLE 3

| Layer | Material | Thickness (nm) |
|---|---|---|
| Incident Medium (s) | InP | |
| 1 | Al₂O₃ | 188.22 |
| 2 | a-Si | 55.03 |
| 3 | Al₂O₃ | 305.19 |
| 4 | a-Si | 65.22 |
| 5 | Al₂O₃ | 270.12 |
| 6 | a-Si | 78.87 |
| 7 | Al₂O₃ | 210.98 |
| Adhesion Promoter | Cr | 0.5 |
| (Optional) | | |
| Exit medium (m) | Au | >20.0 |

The reflectivity of this configuration is 99.6%, which is significantly better than the 99.4% limit of the traditional quarter-wavelength design. At the same time, the dielectric mirror specified in Table 3 has a thermal conductivity that is approximately 1.3 times the thermal conductivity of a quarter-wavelength a—Si and Al₂O₃ mirror, because the total a—Si thickness of this mirror is less than the total thickness of a—Si layers in a quarter-wavelength design.

Although this example uses gold, other reflective metals may be substituted for the gold. Optionally a thin layer of chromium (Cr) may be included as an adhesion promoter for the metal. The chromium should be sufficiently thin so as not to interfere with transmittance.

### EXAMPLE 4

The configuration described above with reference to Table 3 provides improved reflectivity while also incidentally improving thermal conductivity. In other embodiments, enhancement of thermal conductivity can be a specific design target, and may be the primary design target.

In the following example, a multilayer mirror for incident electromagnetic waves including a plurality of layers having different thicknesses. The plurality of layers includes at least two materials. In this example, SiC and MgO are used. Both SiC and MgO have substantially zero absorptance at a wavelength of 1310 nm. Thus, reflectivity would be maximized by using a quarter-wavelength design. However, at least a first one of the materials has a substantially higher thermal conductivity than a second one of the materials. In this case, MgO has significantly higher thermal resistivity (i.e., lower conductivity) than SiC. Thus, designs are considered having SiC thickness greater than one quarter wavelength and MgO thickness less than one quarter wavelength. Configurations can be designed in which a small reduction in reflectivity below that of the quarter wavelength design is accepted in return for a significant improvement in thermal conductivity. In the exemplary configurations, each pair of two consecutive layers has a combined thickness of two quarter-wavelengths.

In one example, 14 alternating layers of 1.22 quarter wavelength SiC and 0.78 quarter wavelength MgO are provided. The thickness of the respective layers of this multilayer mirror provide the multilayer mirror with a reflectivity of 99.4% at a wavelength of 1310 run that is slightly less than the maximum asymptotic reflectivity (99.6%) of a mirror formed of quarter wavelength thick layers of the same materials. (When selecting configurations that improve thermal conductivity, alternative designs may be selected having reflectivities which are greater than, equal to, or slightly less than the reflectivity of a mirror having quarter wavelength thick layers of the same materials and the same number of layers.) The thicknesses of the respective layers of the multilayer mirror provides the multilayer mirror with a thermal conductivity that is substantially (about 20%) greater than the thermal conductivity of a quarter wavelength mirror of the same materials and having the same number of layers.

Although this example has 14 layers, a larger number of layers may be used to increase reflectivity, or a smaller number of layers may be used to improve total thermal conductivity.

Although the SiC and MgO mirror provides an example of an improved thermal conductivity mirror using zero-absorptance materials, the thermal conductivity can also be improved for mirrors in which at least one of the materials is absorptive. Because the quarter-wavelength thickness design does not provide the highest reflectivity when one or both of the materials has a non-zero absorptance, it is possible to enhance both reflectivity and thermal conductivity relative to the quarter-wavelength design when at least one absorptive material is used. Table 3 provides an example in which the mirror has a reflectivity at 1310 nm that is greater than a maximum asymptotic reflectivity of quarter wavelength mirror of the same materials, and the mirror has a thermal conductivity that is substantially greater than the thermal conductivity of a quarter wavelength mirror of the same materials and having the same number of layers as the multilayer mirror.

One of ordinary skill can readily apply the concepts described herein to design and fabricate other highly reflective multilayer mirrors. Physical properties such as absorptance and transmittance at the target wavelength, thermal conductivity or other property of interest to the VCSEL design are identified. Layer thicknesses are then selected based on the physical property and the target reflectivity. The design can be directed at enhancing or maximizing one property, or the design can be selected to strike a balance between two or more properties.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A multilayer mirror for incident electromagnetic waves, comprising:
a plurality of layers having at least two different thicknesses, the plurality of layers including at least two materials;
at least one of the materials having a non-zero absorptance at a given wavelength;
the thicknesses of the respective layers of the multilayer mirror providing the multilayer mirror with a reflectivity at the given wavelength that is greater than a reflectivity of a second mirror formed of quarter wavelength thick layers of the same materials and of the same number of layers as the multilayer mirror.

2. The multilayer mirror of claim 1, wherein:
the at least two materials include a first material having a non-zero absorptance at the given wavelength and a second material having substantially lower absorptance at the given wavelength than the first material; and
the respective thicknesses of the plurality of layers are configured so that during use, an amount of optical power distributed in the first material is substantially less than an amount of optical power distributed in the second material.

3. The multilayer mirror of claim 2, wherein the second material has approximately zero absorptance at the given wavelength.

4. The multilayer mirror of claim 2, wherein the respective thicknesses of the plurality of layers are configured so that during use, optical absorption by the multilayer mirror is minimized.

5. The multilayer mirror of claim 1, wherein the first material is amorphous silicon and the second material is Al₂O₃, and the multilayer mirror has a reflectivity at a 1310 nanometer wavelength of at least 99.6%.

6. The multilayer mirror of claim 5, wherein the multilayer mirror has not more than 12 layers of the first and second materials.

7. The multilayer mirror of claim 5, wherein the multilayer mirror has not more than 8 layers, and the plurality of layers include at least one layer of metal.

8. The multilayer mirror of claim 7, wherein the plurality of layers include 7 layers of the first and second materials and a single layer of metal.

9. The multilayer mirror of claim 8, wherein the multilayer mirror has a thermal conductivity that is approximately 1.3 times the thermal conductivity of the second multilayer mirror.

10. The multilayer mirror of claim 1, wherein the first material is amorphous silicon and the second material is Al₂O₃, and the multilayer mirror has a reflectivity at a 1310 nanometer wavelength of at least 99.8%.

11. The multilayer mirror of claim 10, wherein the multilayer mirror has fewer than 40 layers of the first and second materials.

12. The multilayer mirror of claim 1, wherein the multilayer mirror has a thermal conductivity that is approximately 1.2 times the thermal conductivity of the second multilayer mirror.

13. The multilayer mirror of claim 1, wherein the multilayer mirror has a reflectivity greater than a maximum asymptotic reflectivity of a third multilayer mirror formed of quarter wavelength thick layers of the same materials.

14. A multilayer mirror for incident electromagnetic waves, comprising:
a plurality of layers having at least two different thicknesses, the plurality of layers including at least two materials;
at least one of the materials having a non-zero absorptance at a given wavelength;
each of the materials having a non-zero transmittance at the given wavelength;
the thicknesses of the respective layers of the multilayer mirror providing the multilayer mirror with a reflectivity at the given wavelength that is greater than, equal to, or slightly less than a reflectivity of a second mirror formed of quarter wavelength thick layers of the same materials and the same number of layers as the multilayer mirror, the thicknesses providing the multilayer mirror with a transmittance substantially greater than a transmittance of the second mirror.

15. The multilayer mirror of claim 14, wherein:
the at least two materials include a first material having a non-zero absorptance at the given wavelength and a second material having substantially lower absorptance at the given wavelength than the first material; and
the respective thicknesses of the plurality of layers are configured so that during use, an amount of optical power distributed in the first material is substantially less than an amount of optical power distributed in the second material.

16. The multilayer mirror of claim 15, wherein the second material has approximately zero absorptance at the given wavelength.

17. The multilayer mirror of claim 14, wherein the first material is amorphous silicon and the second material is Al₂O₃, and the multilayer mirror has a reflectivity at a 1310 nanometer wavelength of at least 99.3% and a transmittance of approximately 0.35%.

18. The multilayer mirror of claim 17, wherein the multilayer mirror has not more than 10 layers of the first and second materials.

19. The multilayer mirror of claim 14, wherein the multilayer mirror has a reflectivity greater than a maximum asymptotic reflectivity of a third multilayer mirror formed of quarter wavelength thick layers of the same materials.

20. A multilayer mirror for incident electromagnetic waves, comprising:
a plurality of layers having at least two different thicknesses, the plurality of layers including at least two materials;
at least a first one of the materials having a substantially higher thermal conductivity than a second one of the materials;
the thickness of the respective layers of the multilayer mirror providing the multilayer mirror with a reflectivity at a given wavelength that is greater than, equal to, or slightly less than a reflectivity of a second mirror formed of quarter wavelength thick layers of the same materials and having the same number of layers as the multilayer mirror;
the thickness of the respective layers of the multilayer mirror providing the multilayer mirror with a thermal conductivity that is substantially greater than the thermal conductivity of the second mirror.

21. The multilayer mirror of claim 20, wherein the at least two materials include first and second materials having substantially no absorption at the given wavelength.

22. The multilayer mirror of claim 21, wherein the first material is SiC and the second material is MgO.

23. The multilayer mirror of claim 22, wherein the plurality of layers includes alternating layers of 1.22 quarter wavelength SiC and 0.78 quarter wavelength MgO.

24. The multilayer mirror of claim 22, wherein the plurality of layers includes 14 layers.

25. The multilayer mirror of claim 20, wherein the multilayer mirror has a reflectivity greater than a maximum asymptotic reflectivity of a third multilayer mirror formed of quarter wavelength thick layers of the same materials.

26. A method for constructing a multilayer mirror for incident electromagnetic waves, comprising:
selecting at least two materials to be incorporated into a plurality of layers to form the multilayer mirror, at least one of the materials having a non-zero absorptance at a given wavelength;
selecting a number of layers for the multilayer mirror;
identifying a respective thickness for each of a plurality of layers; and
forming the multilayer mirror using the identified thicknesses, so as to provide the multilayer mirror with a reflectivity at the given wavelength greater than a reflectivity of a second mirror formed of quarter wavelength thick layers of the same materials and having the same number of layers as the multilayer mirror.

27. The method of claim 26, wherein the respective thicknesses of the plurality of layers are selected so that during use, an amount of optical power distributed in the first material is substantially less than an amount of optical power distributed in the second material.

28. The method of claim 26, wherein the respective thicknesses of the plurality of layers are selected so that during use, optical absorption by the multilayer mirror is minimized.

29. The method of claim 26, wherein the respective thicknesses of the plurality of layers are selected so that the multilayer mirror has a thermal conductivity that is approximately 1.2 times the thermal conductivity of the second multilayer mirror.

30. A method for constructing a multilayer mirror for incident electromagnetic waves, comprising:
selecting at least two materials to be incorporated into a plurality of layers to form the multilayer mirror, at least one of the materials having a non-zero absorptance at a given wavelength, each of the materials having a non-zero transmittance at the given wavelength;
selecting a number of layers for the multilayer mirror;
identifying a respective thickness for each of the plurality of layers, so as to provide the multilayer mirror with a reflectivity at the given wavelength that is greater than, equal to or slightly less than a reflectivity of a second mirror formed of quarter wavelength thick layers of the same materials and having the same number of layers as the multilayer mirror, and so as to provide the multilayer mirror with a transmittance substantially greater than a transmittance of the second mirror; and
forming the multilayer mirror with the identified thicknesses.

31. The multilayer mirror of claim 30, wherein:
the at least two materials include a first material having a non-zero absorptance at the given wavelength and a second material having substantially lower absorptance at the given wavelength than the first material; and
the respective thicknesses of the plurality of layers are configured so that during use, an amount of optical power distributed in the first material is substantially less than an amount of optical power distributed in the second material.

32. The multilayer mirror of claim 31, wherein the second material has approximately zero absorptance at the given wavelength.

33. The multilayer mirror of claim 30, wherein the first material is amorphous silicon and the second material is Al₂O₃, and the multilayer mirror has a reflectivity at a 1310 nanometer wavelength of at least 99.3% and a transmittance of approximately 0.35%.

34. The multilayer mirror of claim 33, wherein the multilayer mirror has not more than 10 layers of the first and second materials.

35. A method for constructing a multilayer mirror for incident electromagnetic waves, comprising:
selecting at least two materials to be incorporated into a plurality of layers to form the multilayer mirror, at least a first one of the materials having a substantially higher thermal conductivity than a second one of the materials;
selecting a number of layers for the multilayer mirror;
identifying a respective thickness for each of the plurality of layers so as to provide the multilayer mirror with a reflectivity at the given wavelength that is greater than, equal to or slightly less than a reflectivity of a second mirror formed of quarter wavelength thick layers of the same materials and having the same number of layers as the multilayer mirror,
the thickness of the respective layers of the multilayer mirror providing the multilayer mirror with a thermal conductivity that is substantially greater than the thermal conductivity of the second mirror.

36. The multilayer mirror of claim 35, wherein the at least two materials include first and second materials having substantially no absorption at the given wavelength.

37. The multilayer mirror of claim 36, wherein the first material is SiC and the second material is MgO.

38. The multilayer mirror of claim 37, wherein the plurality of layers includes alternating layers of 1.22 quarter wavelength SiC and 0.78 quarter wavelength MgO.

39. The multilayer mirror of claim 37, wherein the plurality of layers includes 14 layers.
